(19) United States
(12) Patent Application Publication
(10) Pub. No.: US 2022/0284873 A1
(43) Pub. Date: Sep. 8, 2022

(54) TRANSMITTER INTERFACE MODULE FOR MUSICAL INSTRUMENTS

(71) Applicant: Jamstack, Toronto (CA)

(72) Inventor: Chris James PRENDERGAST, Toronto (CA)

(21) Appl. No.: 17/668,436

(22) Filed: Feb. 10, 2022

Related U.S. Application Data
(60) Provisional application No. 63/148,209, filed on Feb. 11, 2021.

(51) Int. Cl. G10H 1/00

(52) U.S. Cl. CPC G10H 1/0083; G10H 1/0008; G10H 2240/211

(57) ABSTRACT

A transmitter interface module for a musical instrument for receiving and converting an analog input audio signal to digital, passing the digital signal to a mobile processing device for digital signal processing, and/or recording, receiving the processed signal from the mobile processing device and transmitting the received processed signal wirelessly for broadcast/performance by a receiver. The transmitter interface module further comprises an input for receiving one of either an analog or digital audio signal, a converter for converting the analog signal to a digital audio signal, a wired connection for sending the digital audio signal to a mobile processing device for digital audio processing and receiving a processed audio signal from the mobile processing device, and a transmitter for wirelessly transmitting the received processed audio signal.

### CROSS REFERENCE TO RELATED APPLICATIONS

The application claims priority to and the benefit of U.S. Provisional Patent Application Ser. No. 63/148,209, entitled “TRANSMITTER INTERFACE MODULE FOR MUSICAL INSTRUMENTS”, filed on Feb. 11, 2021, the disclosure of which is incorporated herein by reference in its entirety.

### BACKGROUND OF THE INVENTION

### 1. Field of the Invention

The present invention relates to musical instrument accessories and in particular to a transmitter interface module for musical instruments.

### 2. Description of the Related Art

Since the advent of the wireless microphone in the early 1960's, wireless techniques have been utilized in vocal and instrumental audio transmitting. Generally, a wireless system comprises three main components: an input device, a transmitter, and a receiver. The input device may be a microphone, or a music instrument such as a guitar. The transmitter converts the input audio signal into a radio signal for broadcast over the air (OTA). The receiver picks up the radio signal via an antenna and converts it back to an audio signal for further processing and/or amplification for performance.

### SUMMARY OF THE INVENTION

It is an aspect of the present invention to provide a module for receiving and converting an analog input audio signal to digital, passing the digital signal to a mobile processing device for digital signal processing and/or recording, receiving the processed signal from the mobile processing device and transmitting the received processed signal wirelessly for broadcast/performance by a receiver.

The above aspects can be attained by a transmitter interface module, comprising an input for receiving one of either an analog or digital audio signal; a converter for converting the analog signal to a digital audio signal; a wired connection for sending the digital audio signal to a mobile processing device for digital audio processing and receiving a processed audio signal from the mobile processing device; and a transmitter for wirelessly transmitting the received processed audio signal.

Another aspect can be attained by a method comprising receiving one of either an analog or digital audio signal; in the event of receiving an analog or digital audio signal converting the analog audio signal to a digital audio signal; sending the digital audio signal to a mobile processing device for digital audio processing; receiving a processed audio signal from the mobile processing device; and wirelessly transmitting the received processed audio signal.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 shows a transmitter interface module for wirelessly interfacing a mobile processing device and a receiver, according to an embodiment.

FIG. 2 is a flowchart showing operation of the transmitter interface module of FIG. 1.

FIGS. 3A and 3B show a transmitter interface module for wirelessly interfacing a mobile processing device and a receiver, according to an alternative embodiment.

FIG. 4 shows a system diagram with the interconnections between the wireless transmitter module, various input sources and the rest of the music signal processing system.

FIG. 5 shows a diagram illustrating a wireless transmitter.

### DETAILED DESCRIPTION OF THE PREFERRED EMBODIMENTS

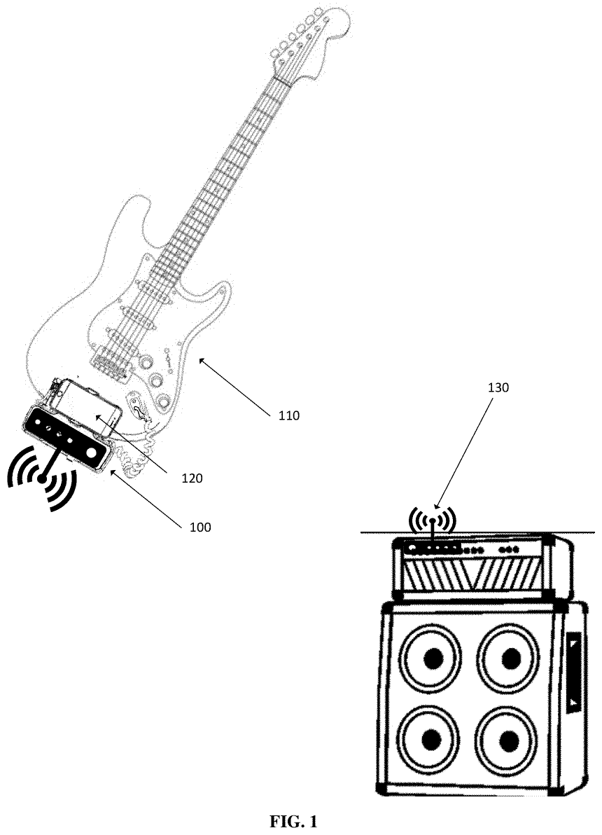

With reference to FIG. 1, a transmitter interface module 100 is shown having an input for receiving an audio signal from an audio source 110, which can be a musical instrument, microphone, etc. In some embodiments, the audio signal may an analog signal whereas in other embodiments the audio signal may be a digital audio signal. The transmitter interface module 100 includes a converter for, when the audio signal is analog, converting the analog signal to a digital audio signal. The transmitter interface module 100 further includes a wired connection for sending the audio signal to a mobile processing device 120 for digital audio processing. The audio signal sent to and from the digital audio processing device 120 may either be an analog or digital signal. In addition, the audio signal sent to and from the digital audio processing device can be a wired connection, or it may be a wireless connection.

The digital audio processing device can process the audio signal using one or more techniques either individually or in combination, the techniques being effects such as equalization, distortion, flanging, time delay, echo, reverb, dynamic range compression or expansion, per-sample algorithmic manipulation, or any combination of these. In addition to processing the audio signal, the digital audio processing device may also record the signal for later use or for creating layered sounds or looping samples. In one embodiment, the transmitter interface module receives a processed audio signal via the wired connection, which may be either an analog or digital signal, from the mobile processing device 120 and may then wirelessly transmit the received processed audio signal to a remote receiver 130 via a transmitter.

The remote receiver 130 may include a wireless signal receiver and may either connect within the same enclosure to a speaker system, or the wireless receiver may be an independently housed receiver with an output connection to speaker systems, recording systems, or other signal processing equipment. In some embodiments, the wireless transmitter may be incorporated into another piece of equipment, such as a musical instrument or microphone. In some embodiments, the wireless receiver may be incorporated into another piece of equipment, such an audio recording, editing or mixing device. In some embodiments the wirelessly transmitted processed audio signal is an analog signal while in other embodiments the wirelessly transmitted processed audio signal is a digital signal.

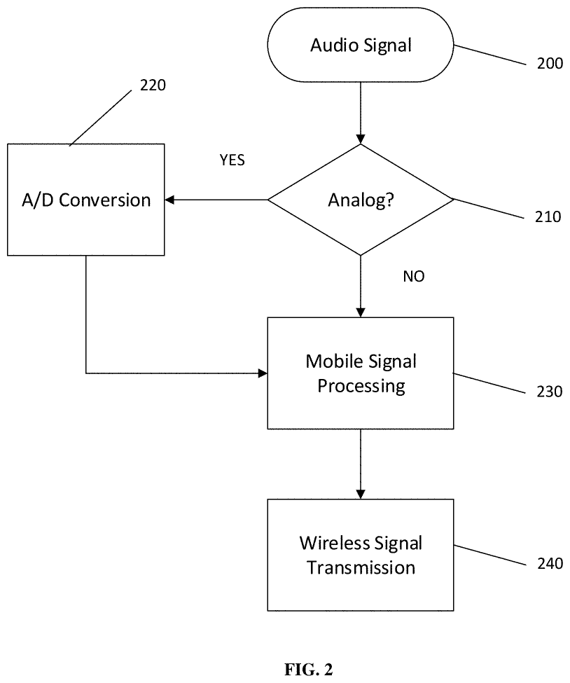

Referring to FIG. 2, a flowchart is provided showing operation of the transmitter interface module 100 of FIG. 1. According to FIG. 2, an audio signal 200 is received from audio source 110. At 210, a determination is made as to whether the received signal is analog or digital. If the signal is analog, the converter converts the analog signal to a digital audio signal at 220. Next, at 230, the mobile processing device 120 performs audio processing on the received digital signal, such as feedback cancellation, distortion, flanging, echo, reverb, time delay, dynamic range compression or expansion, noise reduction, equalization, sampling, recording, some combination of these effects, or some other form of audio processing. Ranges of settings can also be presented to the user such that they can choose between multiple suitable settings. At 240, the transmitter interface module 100 wirelessly transmits the received processed audio signal to remote receiver 130.

The transmitter can be configured to be a single signal that is transmitted to a receiving device such as a loudspeaker, recording or PA system. The transmitter can also be configured as dual or stereo transmitters capable of transmitting to a stereo recording or PA system. This multi-channel capability can also be extended to even more channels through multi-channel transmission systems such as SKAA or multiple UHF channels. The channels can contain the different signals generated through the audio processing modules, which may output multiple audio signals to enhance the listener's sense of spatiality of the sound, for effects such as flanging, chorus, reverb, or any other effect which may benefit from multiple channels.

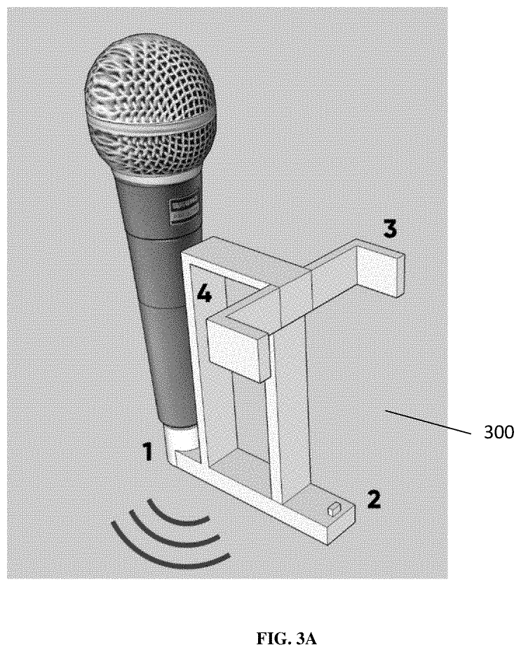

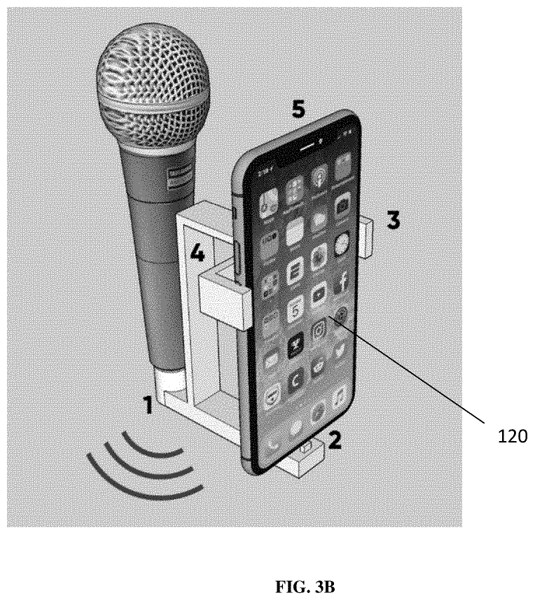

Turning to FIGS. 3A and 3B, a transmitter interface module 300 is shown, according to an alternative embodiment. In the embodiment of FIGS. 3A and 3B, the transmitter interface module 300 comprises a wireless transmitter 1, a USB port 2 for the mobile processing device 120, a mount 3 and a hand grip 4.

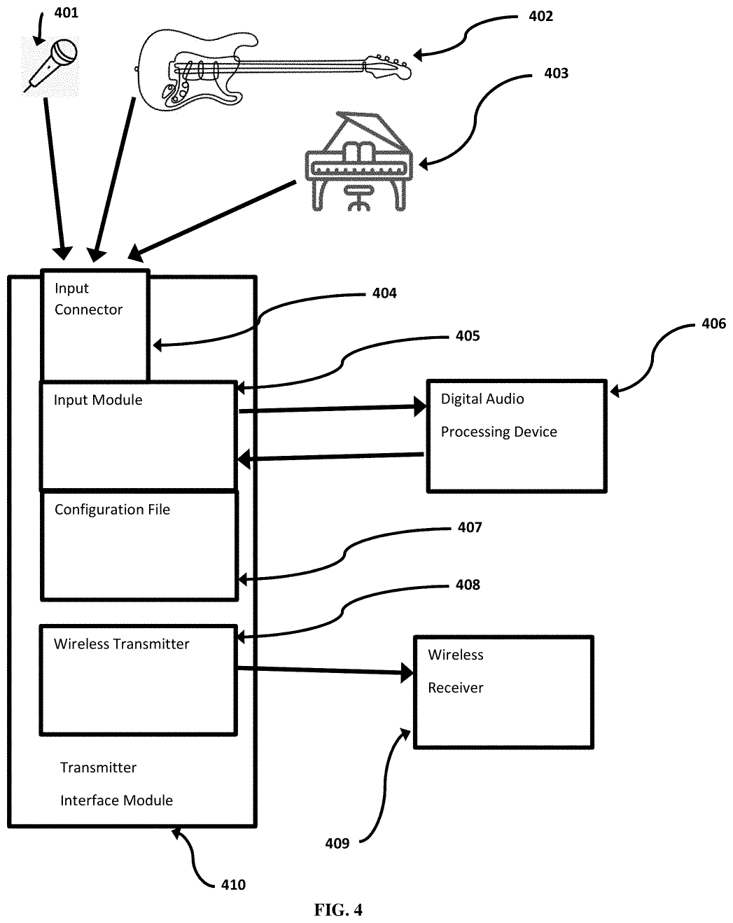

Turning to FIG. 4, The transmitter interface module 410 is shown in one of the preferred embodiments. The Transmitter Interface Module contains at least one Input Connector that electrically connects at least one of several possible signal sources (401, 402, 403) to the Transmitter Interface Module through Input Connector 404. The Input Connector may be realized as a standard connector in the music industry, for example any one of a ¼″ audio jack, a 3 pin XLR connector, a mono or stereo TRS connector, a hybrid connector such as combined ¼″ and XLR connector, an RCA connector, a wired digital audio connector such as S/PDIF, a digital data connector such as USB, or a wireless connector such as a Bluetooth connection.

In most cases, the desired type of audio processing depends on the musical instrument type that is connected. For example, often a guitarist would desire a range of distortion effects, whereas a vocalist would typically desire ambient effects such as reverb or echo, and not want any distortion at all. Further certainty regarding the type of connected instrument or signal source can be obtained by providing an interface connector that is coded to represent the type of instrument connected. For example, connector type A could have a mechanical or electrical feature that the Input Connector 404 uses to determine which type of instrument is connected. The other side of connector type A would have the normal connector to that type of instrument. Another detection method could be a switch attached to or proximal to the input connector that detects the presence of a connected plug.

The identification of the type of musical instrument can be obtained by measuring the electrical attributes of the connected instrument, for example by measuring the impedance of the connected instrument. In many cases, the type of instrument can be identified by a simple impedance measurement with well-known impedance measuring techniques, for example a guitar coil may have an impedance of 470 K ohms to 1 M ohms, whereas a typical microphone may have an impedance of approximately 150 ohms. For instruments that may be non-distinguishable with this simple measurement, an additional step of measuring the impedance at various frequencies can identify the instrument type and with sufficient sample points, identify the manufacturer and model number of the connected instrument.

Another method of identifying the instrument attached would be through analysis of the frequency spectrum of the signal generated by the instrument. For example, a synthesizer keyboard may generate frequency content both above and below the range of human hearing, while a bass guitar may not generate much frequency content above some value such as 5 kHz.

In addition to the identification methods discussed above, many electrical or electronic instruments have a unique noise signature. For example, a single coil guitar pickup will often have significant white noise at the output, whereas an instrument such as a synthesizer keyboard will have a quieter noise profile. This noise signature may be used to identify the type of instrument attached.

Other types of connection to instruments or sound generating devices can be determined by examining the input signals for the characteristics of a digital signal such as S/PDIF, USB or IEC 61397. Digital signals according to these standards or similar standards can be detected by measuring the digital signals on the input and determining if they have the characteristics of a digital input signal. Specifically, the determinations would be made by detecting specific patterns that are characteristic of those digital protocols (Bit patterns and inter-bit timing). When an input signal is determined to be a digital input signal, the effects can be adjusted to suit that type of signal as discussed above.

In another embodiment, in many cases it is important to know whether the source signal is one channel or more than one channel. Audio signals can be presented in the format of a ¼″ or ⅛plug that can have two or more conductors. Normally, two-conductor plugs carry a mono signal which consists of a ground on the ‘ring’ part of the plug and carry the active signal on the tip. Other configurations, such as TRS (Tip Ring Sleeve) are also ¼″ or ⅛″ and consist of 3 conductors. These connectors are capable of carrying either two separate signals from the instrument or are capable of carrying a differential signal plus ground for one signal. By measuring if the input signals are different, or are out of phase versions of one signal, a determination can be made regarding whether the input is monophonic or if it is a stereo signal. When an input signal is determined to be either a mono or a stereo input signal, the effects can be adjusted to suit that type of signal as discussed above.

The Input Connector may be either a number of separate connectors, or may be, as previously stated, a combined connector. In either case, the presence of one of the types of connected signal sources can be detected by techniques well known in the industry. The input type can then be used to consult a configuration file, to obtain a database entry for that particular type of instrument. This configuration file may be an index that specifies a particular setting or ‘patch’ that the Digital Audio Processing Device 406 should be set to as a default for that instrument. Other internal configurations, such as signal routing, dynamically selectable input or output impedances, signal protocol selection, pre-processing gain, or any other configuration setting, may also be set based on the type of input source detected.

In addition, a first audio processing device (not shown) can be included in the Input Module 405 that can also have configuration parameters included in the Configuration File 407 to configure the signal processing done by the first audio processing device. The Input Module 405 can also selectively route the audio signal through the external second Digital Audio Processing Device 406 depending on the user's preference and whether such a device is connected. In the absence of Digital Audio Processing Device 406, the audio signal would be routed through the first audio processing device and then directly to the Wireless Transmitter 408.

Further refinement can be made by detecting the model and type of connected instrument, for example, by measuring the impedance of a microphone or electric guitar to establish an ideal subset of signal processing settings for that instrument. If the connection to the instrument is made over a digital connection like Bluetooth, specific digital information regarding the type of connected instrument can be transmitted from the instrument to the Transmitter Interface Module. Such information may be signaled either in-band or out of band.

Information from the Configuration File 407 is sent to the Digital Audio Processing Device 406 to instruct the Digital Audio Processing Device 406 to configure itself to process the audio stream in preferred way. The audio stream is sent along the same connection as the information from the Configuration File, processed by the Digital Audio Processing Device, and then returned to the Input Module. In addition, the Digital Audio Processing Device 406 can be in the same housing as the input module 410 for configurations where either a separate Digital Audio Processing Device is not available, or configurations where additional signal processing is beneficial to the desired sound. Such additional signal processing could be realized, for example, by having a first sound modification algorithm performed with a processing device in the Transmitter Interface Module housing 410 while a second computationally complex processing algorithm such as reverb is performed by the external Digital Audio Processing Device,

The Input Module then relays the processed audio, in either digital or analog form, to the Wireless Transmitter 408 to be converted to wireless signals for transmission to the Wireless Receiver 409.

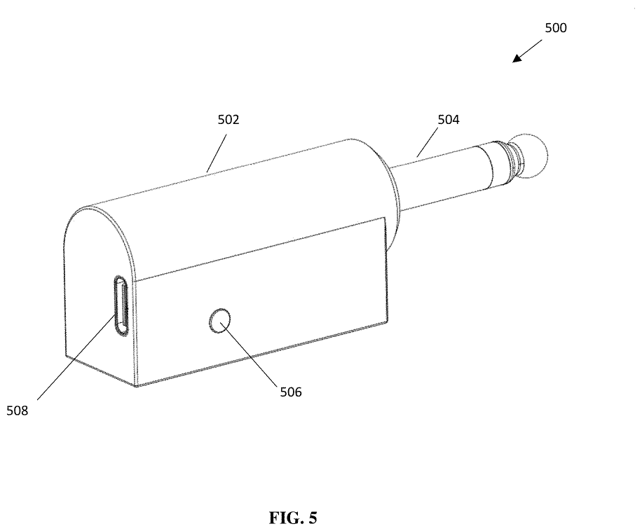

FIG. 5 shows a diagram illustrating a wireless transmitter. According to FIG. 5, wireless transmitter 500 consists of enclosure 502, audio jack 504, button 506 and USB connection port 508. USB connection port 508 will allow wireless transmitter 500 to connect to a USB power supplier to charge wireless transmitter 500. Pressing button 506 will initiate a Bluetooth connection to a mobile device. In further instances, pressing button 506 may be programmed to initiate other functionalities.

According to embodiments of this disclosure, a transmitter interface module is disclosed. The transmitter interface module consists of an input for receiving one of either an analog or digital audio signal, a converter for converting the analog signal to a digital audio signal, a connection for sending the audio signal to a mobile processing device for digital audio processing and receiving a processed audio signal from the mobile processing device, and a transmitter for wirelessly transmitting the received processed audio signal.

According to embodiments of this disclosure, the transmitter interface module includes a USB port, a mount for receiving the mobile processing device and a hand grip, The transmitted signal of the transmitter interface module is a stereo signal and consists of greater than two signals.

According to embodiments of this disclosure, the mobile processing device of the transmitter interface module includes at least one signal processor configured to detect a type of audio source. The audio source is selected through measurement of the instrument impedance. Furthermore, the at least one signal processor is configured based on the detection of the type of instrument connected to the input.

According to embodiments of this disclosure, a method of processing audio signals is disclosed, the method comprises the steps of receiving one of either an analog or digital audio signal, in the event of receiving an analog or digital audio signal converting the analog audio signal to a digital audio signal, sending the digital audio signal to a mobile processing device for digital audio processing, receiving a processed audio signal from the mobile processing device and wirelessly transmitting the received processed audio signal.

According to embodiments of this disclosure, the mechanism for detecting the type of instrument is the detection of the state of a mechanical switch enabled to detect the presence of a connected input. The mechanism for detecting the type of instrument is based on an impedance measurement of the connected input. The mechanism for detecting the type of instrument is based on the noise characteristics of the input. The mechanism for detecting the type of instrument is based on detection of digital signals on at least one input.

According to embodiments of this disclosure, a system of selecting signal processing is disclosed. This system consists of an input for receiving an analog or digital audio signal, a mechanism for detecting the type of instrument connected to the input, a mechanism for configuring one or more signal processors according to the type of instrument, a converter for converting the analog signal to a digital audio signal, a connection for sending the audio signal to one or more audio processing devices for digital audio processing. The system further comprises the steps of receiving a processed audio signal from the mobile processing device and includes a transmitter for wirelessly transmitting the received processed audio signal.

In further embodiments, metadata could be transmitted down the audio stream that then controls parameters of the receiver or system connected to that receiver. This metadata could come from button input on the transmitter enclosure, smart device input, or input from further control accessories that are connected to the transmitter through, for example, the USB-C port. For example, these could be control knobs that send metadata to the receiver & amplifier that are mapped to signal processing parameters.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A transmitter interface module, comprising:
an input for receiving one of either an analog or digital audio signal;
a converter for converting the analog signal to a digital audio signal;
a connection for sending the audio signal to a mobile processing device for digital audio processing and receiving a processed audio signal from the mobile processing device; and
a transmitter for wirelessly transmitting the received processed audio signal.

2. The transmitter interface module of claim 1, wherein the connection is a USB port.

3. The transmitter interface module of claim 1, further comprising a mount for receiving the mobile processing device and a hand grip.

4. The transmitter interface module of claim 1, wherein the transmitted signal is a stereo signal.

5. The transmitter interface module of claim 1, wherein the transmitted signal consists of greater than two signals.

7. The transmitter interface module of claim 1, wherein the mobile processing device is at least one signal processor configured to detect a type of audio source.

8. The transmitter interface module of claim 7, wherein the audio source is selected through measurement of the instrument impedance.

9. The transmitter interface module of claim 7, wherein the at least one signal processor is configured based on the detection of the type of instrument connected to the input.

10. A method of processing audio signals, the method comprising the steps of:
receiving one of either an analog or digital audio signal;
in the event of receiving an analog or digital audio signal converting the analog audio signal to a digital audio signal;
sending the digital audio signal to a mobile processing device for digital audio processing;
receiving a processed audio signal from the mobile processing device; and
wirelessly transmitting the received processed audio signal.

11. The method of claim 10 wherein the mechanism for detecting the type of instrument is the detection of the state of a mechanical switch enabled to detect the presence of a connected input.

12. The method of claim 10 wherein the mechanism for detecting the type of instrument is based on an impedance measurement of the connected input.

13. The method of claim 10 wherein the mechanism for detecting the type of instrument is based on the noise characteristics of the input.

12. The method of claim 8 wherein the mechanism for detecting the type of instrument is based on detection of digital signals on at least one input.

13. A system of selecting signal processing, comprising:
an input for receiving an analog or digital audio signal;
a mechanism for detecting the type of instrument connected to the input;
a mechanism for configuring one or more signal processors according to the type of instrument;
a converter for converting the analog signal to a digital audio signal;
a connection for sending the audio signal to one or more audio processing devices for digital audio processing and receiving a processed audio signal from the mobile processing device; and
a transmitter for wirelessly transmitting the received processed audio signal.
